(19) United States
(12) Patent Application Publication
(10) Pub. No.: US 2006/0284853 A1
(43) Pub. Date: Dec. 21, 2006

(54) Context sensitive data input using finger or fingerprint recognition

(75) Inventor: Steven Curtis Shapiro, Lake Worth, FL (US)

Correspondence Address: AKERMAN SENTERFITT, P.O. BOX 3188, WEST PALM BEACH, FL, 33402-3188, US

(73) Assignee: XM Satellite Radio, Inc., Washington, DC (US)

(21) Appl. No.: 11/154,861

(22) Filed: Jun. 16, 2005

(51) Int. Cl. G09G 5/00

(52) U.S. Cl. 345/173

(57) ABSTRACT

A context sensitive data input device (30) and method (100) can include a touch sensitive surface (32) such as a touchscreen and a processor (34) coupled to the touch sensitive surface. The processor can be programmed to map (102) at least one finger to at least one among a function and a data entry, recognize (104) at least one finger that has been mapped, and execute (108) the function or enter the data entry upon recognizing the at least one finger. The processor can be further programmed to map at least one finger to a short-cut menu or to a preset channel. The processor can also be programmed to recognize fingers of different users and to automatically switch to a particular user's settings, requirements or preferences upon recognizing a finger of a particular user.

### CROSS-REFERENCE TO RELATED APPLICATIONS

(NOT APPLICABLE)

### FIELD OF THE INVENTION

The invention relates generally to a methods and systems for data entry, and more particularly to a data entry scheme using finger or fingerprint recognition.

### BACKGROUND OF THE INVENTION

Satellite radio currently offers well over a hundred channels of content. The existing schemes to select channels has conventionally used either a scroll entry method, a channel preset selection method or a direct numeric channel entry method where 10 discrete numeric keys are utilized. Scroll entry can become burdensome when having to scroll through a long list of channel numbers. Furthermore, as with most other technologies, there continues to be a drive towards designing smaller devices. Although there is a great convenience in being able to enter a channel number directly such as the numbers “1-7-5” using discrete keys, the drive toward smaller devices places increased pressure on the utilization of real estate for such discrete keys and a hindrance in the design of smaller and smaller devices.

### SUMMARY OF THE INVENTION

A scheme to enter data applicable to any future portable device requiring a quick entry of numeric or other data using a recognition device such as a touchscreen with fingerprint recognition. This scheme can be useful in devices being driven to eliminate keys or keypads and towards use of data entry with a touchscreen or touchpad.

In accordance with a first embodiment of the present invention, a context sensitive data input device can include a touch sensitive surface such as a touchscreen and a processor coupled to the touch sensitive surface. The processor can be programmed to map at least one finger to at least one among a function and a data entry, recognize at least one finger that has been mapped, and execute the function or enter the data entry upon recognizing the at least one finger. The processor can be further programmed to map at least one finger to a short-cut menu or to a preset channel for example. The processor can also be programmed to recognize fingers of different users and to automatically switch to a particular user's settings, requirements or preferences upon recognizing a finger of a particular user. In other variants, the processor can be programmed to recognize multiple fingers used simultaneously or in a particular sequence for additional functions or input entries.

In one variation of the first embodiment, the processor can be programmed to map a user's ten fingers to respective numeric digits 0-9 or alternatively programmed to map a user's 5 fingers to respective numeric digits 0-4 when used on a first portion of the touch sensitive surface and to respective numeric digits 5-9 when used on a second portion of the touch screen. The context sensitive data input device can map and recognize fingers using at least one technique selected among fingerprint recognition and finger shape recognition. The processor can also be programmed to recognize at least two among a first finger as a left click, a second finger as a right click, and a third finger as a scrolling input when the context sensitive data input device essentially operates as a mouse.

In a second embodiment, a device having a user interface having a context sensitive data input device can include a touch sensitive surface and a processor coupled to the touch sensitive surface. As described above, the processor can be programmed to map at least one finger to at least one among a function and a data entry, to recognize at least one finger that has been mapped, and to execute the function or enter the data entry upon recognizing the at least one finger. Note, the device can be any number of devices including, but not limited to a satellite digital radio, a cellular phone, a remote control, a laptop computer, a mouse, a game controller, a personal digital assistant, a desktop computer, and a kiosk with a touch sensitive screen.

In a third embodiment, a method of using a touch screen as a context sensitive data input device can include the steps of mapping at least one finger to at least one among a function and a data entry, recognizing at least one finger that has been mapped, and performing at least one among an execution of the function or an entering of the data entry upon recognizing the at least one finger.

### BRIEF DESCRIPTION OF THE DRAWINGS

FIG. 1 is block diagram of an existing satellite digital audio radio.

FIG. 2 is an illustration of a device having a touch sensitive surface such as a touchscreen in accordance with an embodiment of the present invention.

FIG. 3 is a block diagram of a device having a touch sensitive surface in accordance with an embodiment of the present invention.

FIG. 4 is an illustration showing a mapping of numeric digits to a user's fingers on both the left and right hands in accordance with one embodiment of the present invention.

FIG. 5 is an illustration showing a mapping of ten numeric digits to a user's fingers on a single hand in accordance with another embodiment of the present invention.

FIG. 6 is an illustration showing a mapping of channel presets, or menu shortcuts, or functions in accordance with another embodiment of the present invention.

FIG. 7 is an illustration showing a mapping of a function or data entry using multiple fingers in accordance with an embodiment of the present invention.

FIG. 8 is an illustration showing another mapping of a function or data entry using multiple fingers in accordance with an embodiment of the present invention.

FIG. 9 is a block diagram of a device such as a mouse in accordance with an embodiment of the present invention.

FIG. 10 is a flow chart illustrating a method of using a touch screen as a context sensitive data input device in accordance with an embodiment of the present invention.

### DETAILED DESCRIPTION OF THE DRAWINGS

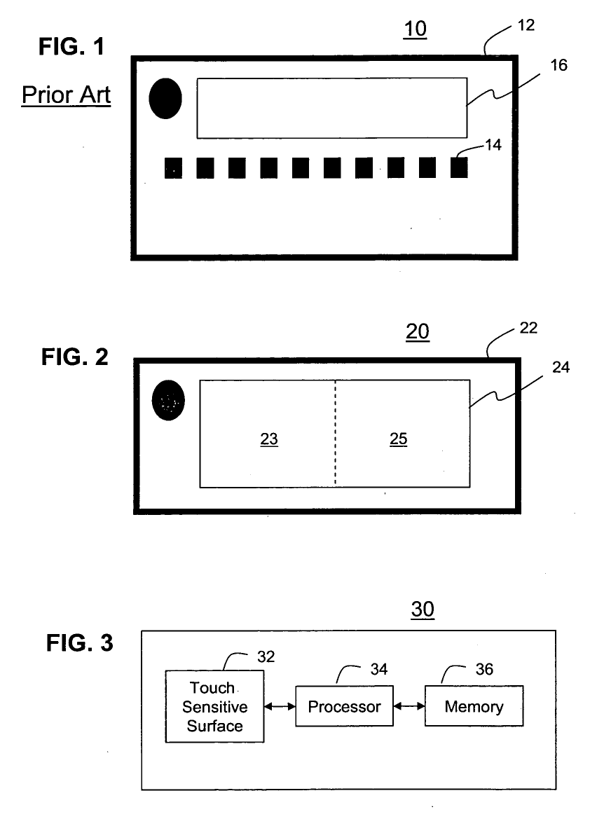

Referring to FIG. 1, a conventional satellite radio 10 is shown having a housing 12, a conventional display 16 such as an LCD display and a plurality of tactile entry devices or buttons 14 used for data entry. The buttons 14 are typically used for either setting and selecting a number of channel presets or can alternatively be used as numeric key entry inputs for selecting a particular channel. For example, if a user wanted channel 170, he or she could press the “1”, the “7”, and the “0” buttons to selected such channels. In a smaller device, where real estate on the device is at a premium, the use of ten numeric keys to provide such functions might be considered a luxury or impractical.

Referring to FIG. 2, a smaller device 20 includes a housing 22 having a touch sensitive surface 24 such as a touchscreen. The touchscreen can be compartmentalized into two or more areas such as areas 23 and 25. As shown in FIG. 3, a similar device 30 can include a touch sensitive surface 32 coupled to a processor 34 and a memory 36. Thus, a particular user's fingerprints (all or a subset) or their particular finger shapes be scanned and assigned or mapped to a numeric digit for each finger for quick entry of numeric data. Note, embodiments of the present invention are not necessarily limited to mapping fingers to numeric digits, but could also include mapping fingers to functions, menu shortcuts, or even alphanumeric or other types of data entry inputs. Furthermore, multiple fingers can be mapped to a single function or data entry and as previously noted the mapping and recognition is not necessarily limited to fingerprint recognition or shape recognition. Essentially, any type of recognition that can uniquely assign a user's distinguishable biometric data (such as fingerprints) to a particular function or data entry can be used.

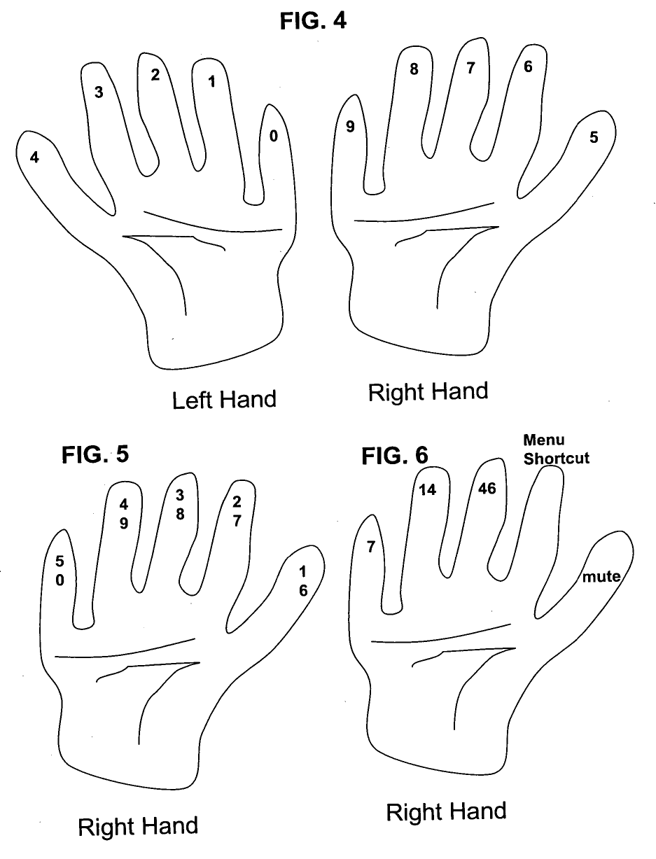

In one example as illustrated in FIG. 4 (with palms facing out of the page), using 10 scanned fingers from left to right (when hands are faced down) assigned respectively digits 0 through 9, a user could enter channel 170 by merely pressing their second finger down on the left hand, then middle finger/right hand, then pinky on left hand. With a touch sensitive surface, it wouldn't matter where the finger presses on the screen since the fingerprint or finger shape recognition correlates to the input number and not the location on the screen. Such arrangement also enables a manufacturer or designer to utilize a smaller screen overall if desired.

In another embodiment or in another mode, the user can scan-in or map just 5 fingers (on the right hand for example) and use two separate areas (such as areas 23 and 25 of FIG. 2 for example) on the touch pad to provide digits 1-5 on first area 23 of the touchpad and digits 6, 7, 8, 9 and 0 on a second area 25. The mapping to the fingers can look like right hand mapping of FIG. 5 where the thumb maps to 1 and 6, the index finger to 2 and 7, the middle finger to 3 and 8, the fourth finger to 4 and 9 and the pinky to 6 and 0. Entering 170 would involve pressing the thumb on the first area 23, index finger on the second area 25, and then the pinky on the second area 25. As noted above, such finger mapping to digits can be done in any number of ways and this is merely an example.

Referring to FIG. 6, another mapping to fingers on a right hand can also include mapping individual fingers to particular channel presets, menu shortcuts, or functions. In this example, assuming the device is an XM Satellite Radio having well over a hundred channels, the thumb can be assigned to a function such as a mute function, the index finger to a menu shortcut, the middle finger to a preset channel 48 for classic rock, the fourth finger to channel 14 for bluegrass music, and the pinky can be assigned to preset channel 7 for 70's music. Thus, the user can essentially assign each finger to a number of functions, shortcuts or data entries as desired. As previously noted, the user can also assign or map multiple fingers in combination to a particular function. As illustrated in FIGS. 7 and 8, two fingers in combination can be assigned to a function or data entry 70 and another two finger combination to a function or data entry 80. Note, three, four, or all fingers scanned-in simultaneously can also be mapped to different functions or data entries. Further note, in another alternative embodiment, the user can scan in a particular sequence of finger presses and such recognized sequence of fingers can also provide additional mapping opportunities to functions and data entries.

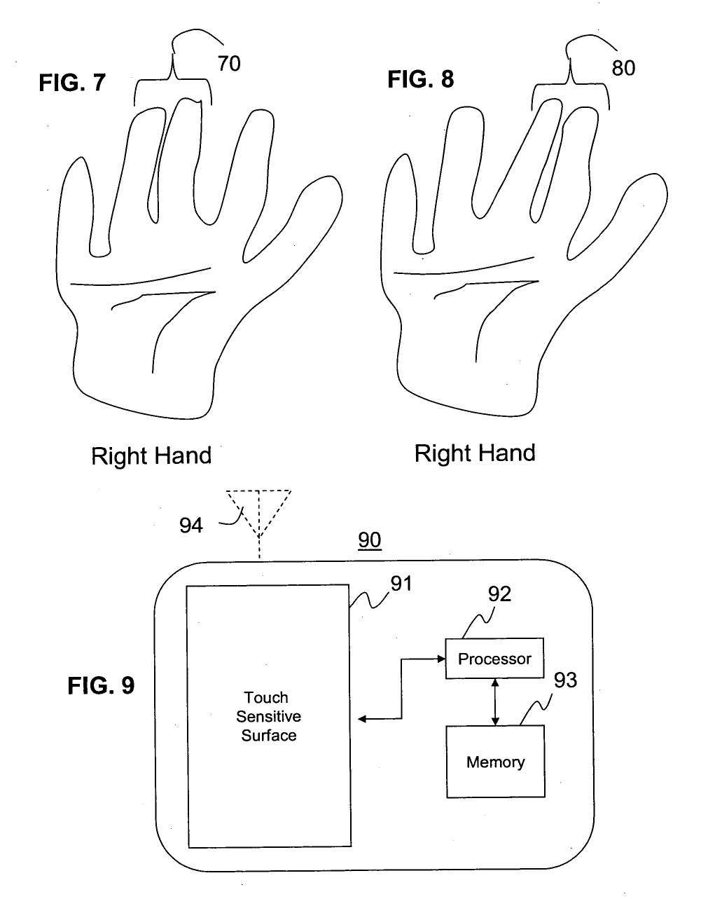

Referring to FIG. 9, a device 90 in accordance with the embodiments can be any number of devices including, but not limited to a satellite digital radio, a cellular phone, a remote control, a laptop computer, a mouse, a game controller, a personal digital assistant, a desktop computer, or a kiosk with a touch sensitive screen. Such devices can default to this type of fingerprint-recognition-numeric-key assignment mode upon detecting a finger upon a touch sensitive surface 91. The device 90 can include a context sensitive data input device including the touch sensitive surface 91 such as a touchscreen and a processor 92 coupled to the touch sensitive surface 91. The processor 92 can be programmed to map at least one finger to at least one among a function and a data entry, recognize at least one finger that has been mapped, and execute the function or enter the data entry upon recognizing the at least one finger. The processor 92 can be further programmed to map at least one finger to a short-cut menu or to a preset channel for example. The processor 92 can also be programmed to recognize fingers of different users and to automatically switch to a particular user's settings, requirements or preferences upon recognizing a finger of a particular user. In other variants, the processor 92 can be programmed to recognize multiple fingers used simultaneously or in a particular sequence for additional functions or input entries. The device 90 can further include a memory 93 coupled to the processor 92 that can store finger shapes or fingerprint information and mappings and other settings, preferences as well as algorithms than can perform the mapping and recognition. The device can also include an antenna 94 as needed for wireless communication using Bluetooth, cellular, paging, WiFi, Satellite or any other communication technology or protocol.

In the case the device 90 is a mouse, the processor 92 can also be programmed to recognize at least two among a first finger as a left click, a second finger as a right click, and a third finger as a scrolling input when the context sensitive data input device 90 essentially operates as a mouse.

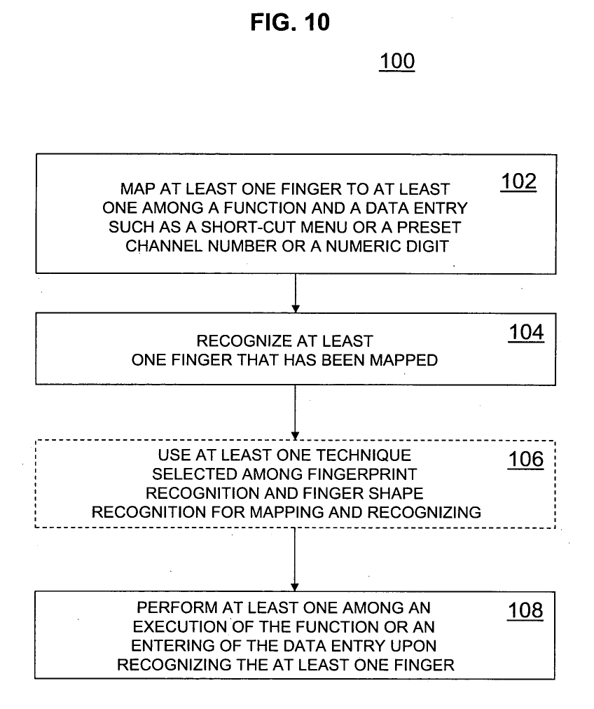

Referring to FIG. 10, a flow chart illustrates a method 100 of using a touch sensitive surface as a context sensitive data input device that can include the steps of mapping at least one finger to at least one among a function and a data entry (such as a shortcut menu, a preset channel, or a numeric digit) at step 102, recognizing at least one finger that has been mapped at step 104, and performing at least one among an execution of the function or an entering of the data entry upon recognizing the at least one finger at step 108. Note, at step 106, fingerprint recognition or finger shape recognition can be used for the mapping (102) and recognition (104) functions. The function mapped and executed can be any function including simply turning a device on or off for example.

The description above is intended by way of example only and is not intended to limit the present invention in any way except as set forth in the following claims.

We claim:

1. A context sensitive data input device, comprising:
a touch sensitive surface;
a processor coupled to the touch sensitive surface, wherein the processor is programmed to:
map at least one finger to at least one among a function and a data entry;
recognize at least one finger that has been mapped; and
execute the function or enter the data entry upon recognizing the at least one finger.

2. The context sensitive data input device of claim 1, wherein the touch sensitive surface is a touchscreen.

3. The context sensitive data input device of claim 1, wherein the processor is programmed to map at least one finger to a short-cut menu.

4. The context sensitive data input device of claim 1, wherein the processor is programmed to map at least one finger to a preset channel.

5. The context sensitive data input device of claim 1, wherein the processor is further programmed to recognize fingers of different users.

6. The context sensitive data input device of claim 5, wherein the processor is further programmed to automatically switch to a particular user's settings, requirements or preferences upon recognizing a finger of a particular user.

7. The context sensitive data input device of claim 1, wherein the processor can be further programmed to recognize multiple fingers used simultaneously for additional functions or input entries.

8. The context sensitive data input device of claim 1, wherein the processor can be further programmed to recognize multiple fingers used in a particular sequence for additional functions or input entries.

9. The context sensitive data input device of claim 1, wherein the processor is programmed to map a user's ten fingers to respective numeric digits 0-9.

10. The context sensitive data input device of claim 1, wherein the processor is programmed to map a user's 5 fingers to respective numeric digits 0-4 when used on a first portion of the touch sensitive surface and to respective numeric digits 5-9 when used on a second portion of the touch screen.

11. The context sensitive data input device of claim 1, wherein the device is a mouse and wherein the processor is programmed to recognize at least two among a first finger as a left click, a second finger as a right click, and a third finger as a scrolling input.

12. The context sensitive data input device of claim 1, wherein the device maps and recognizes fingers using at least one technique selected among fingerprint recognition and finger shape recognition.

13. A device having a user interface having a context sensitive data input device, comprising:
a touch sensitive surface;
a processor coupled to the touch sensitive surface, wherein the processor is programmed to:
map at least one finger to at least one among a function and a data entry;
recognize at least one finger that has been mapped; and
execute the function or enter the data entry upon recognizing the at least one finger.

14. The device of claim 13, wherein the device is selected among the group of devices comprising a satellite digital radio, a cellular phone, a remote control, a laptop computer, a mouse, a game controller, a personal digital assistant, a desktop computer, and a kiosk with a touch sensitive screen.

15. The device of claim 13, wherein the device is a satellite digital audio radio having a plurality of channels and the processor is programmed to map a plurality of fingers to a plurality numeric digits used for channel selection.

16. The device of claim 13, wherein the device maps and recognizes fingers using at least one technique selected among fingerprint recognition and finger shape recognition.

17. A method of using a touch screen as a context sensitive data input device, comprising the steps of:
mapping at least one finger to at least one among a function and a data entry;
recognizing at least one finger that has been mapped; and
performing at least one among an execution of the function or an entering of the data entry upon recognizing the at least one finger.

18. The method of claim 17, wherein the step of mapping further comprises the step of mapping at least one finger to at least one among a short-cut menu and a preset channel.

19. The method of claim 18, wherein the steps of mapping and recognizing further comprises using at least one technique selected among fingerprint recognition and finger shape recognition.

20. The method of claim 17, wherein the step of mapping comprises the step of mapping at least one finger to a function of turning the context sensitive data input device on or turning the context sensitive data input device off and the step of performing comprises the execution of the function selected from turning on and turning off.
